(19) United States
(12) Patent Application Publication
(10) Pub. No.: US 2021/0189160 A1
(43) Pub. Date: Jun. 24, 2021

(54) INKJET INK COMPOSITION

(71) Applicant: HEWLETT-PACKARD DEVELOPMENT COMPANY, L.P., Spring, TX (US)

(72) Inventors: Sundar VASUDEVAN, Corvallis, OR (US); Raymond ADAMIC, Corvallis, OR (US); Max YEN, San Diego, CA (US)

(73) Assignee: Hewlett-Packard Development Company, L.P., Spring, TX (US)

(21) Appl. No.: 17/047,021

(22) PCT Filed: Apr. 30, 2018
(86) PCT No.: PCT/US2018/030217

§ 371 Date: Oct. 12, 2020

(51) Int. Cl. C09D 11/322; C09D 11/38; C09D 11/037; C09D 11/033; C09B 67/22; C09B 47/04; C09B 48/00; B41M 5/00

(52) U.S. Cl. CPC C09D 11/322; C09D 11/38; C09D 11/037; B41M 5/0023; C09B 67/0036; C09B 47/045; C09B 48/00; C09D 11/033

(57) ABSTRACT

An example of an inkjet ink composition includes a pigment, a dispersion synergist, a metal oxide, a polar solvent and water. The pigment is selected from the group consisting of a quinacridone and a phthalocyanine. The dispersion synergist has a structure of the pigment substituted with at least one solubilizing moiety selected from the group consisting of an ionic moiety, a non-ionic moiety, and a combination thereof.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Some commercial and industrial inkjet printers utilize fixed printheads and a moving substrate web in order to achieve high speed printing. Current inkjet printing technology involves forcing the ink drops through small nozzles by thermal ejection, piezoelectric pressure or oscillation onto the surface of the media. The technology has become a popular way of recording images on various media surfaces (e.g., paper), for a number of reasons, including, low printer noise, capability of high-speed recording and multi-color recording.

### BRIEF DESCRIPTION OF THE DRAWINGS

Features of examples of the present disclosure will become apparent by reference to the following detailed description and drawings.

FIG. 1 is a flow diagram of a method of making an example of the inkjet ink composition disclosed herein;

FIGS. 2A and 2B are graphs showing the color saturation of example and comparative example cyan inks printed on enhanced paper and plain paper (2A), and of the example and comparative example cyan inks printed with yellow ink (to form green prints) on enhanced paper and plain paper (2B), at different ink limits; and

FIGS. 3A and 3B are graphs showing the color saturation of example and comparative example magenta inks printed on enhanced paper and plain paper (3A), and of the example and comparative example magenta inks printed with yellow ink (to form red prints) on enhanced paper and plain paper (3B), at different ink limits.

### DETAILED DESCRIPTION

In inkjet printing, the ink composition can affect both the printability of the ink and the print attributes of images that are formed with the ink. As such, ink performance, in terms of both printability and printed image attributes, may be controlled by modifying the components of the ink composition. It is also desirable for the ink composition to be stable so that the ink can be jetted reliably. By “stable,” it is meant that the solid components remain dispersed in the ink vehicle. Unstable inks may impact print nozzle health, print reliability and print consistency.

A single ink composition that is adjusted, for example, to achieve one or more image attributes and stability, may also exhibit different print performance attributes on different types of media, due in part, to the different components within the different types of media. Print performance attributes that may vary from one media type to another may include color saturation of the printed image, dry times of the printed image, and durability of the printed image. An ink composition may form very different prints when printed, for example, on plain paper and on enhanced paper.

As used herein, “plain paper” refers to paper that has not been specially coated or designed for specialty uses (e.g., photo printing). Plain paper is composed of cellulose fibers and fillers. In contrast to an enhanced paper (described below), plain paper does not include an additive that produces a chemical interaction with a pigment in an ink that is printed thereon. Also as used herein, “enhanced paper” refers to paper that has not been specially coated, but does include the additive that produces a chemical interaction with a pigment in an ink that is printed thereon. The enhanced paper is composed of cellulose fibers, fillers, and the additive. An example of the additive is calcium chloride or another salt that instantaneously reacts with an anionic pigment present in the ink printed on the enhanced paper, which causes the pigment to crash out of the ink and fixes the pigment on the enhanced paper surface. As an example, the enhanced paper may be any standard paper that incorporates COLORLOK® Technology (International Paper Co.). Both plain paper and enhanced paper are commercially available as general office printer and/or copier papers, but, as previously mentioned, the enhanced paper incorporates the COLORLOK® Technology. Examples of plain paper used herein include Staples copy paper, Georgia-Pacific Spectrum Multipurpose paper (from Georgia-Pacific), and Hammermill Great White 30 (from Hammermill). An example of enhanced paper used herein is HP® Multipurpose paper media with COLORLOK® technology (from HP Development Company).

An inkjet ink composition is disclosed herein that is stable, and exhibits excellent and relatively consistent color saturation when printed on both plain paper and enhanced paper.

The inkjet ink composition is formed with a pigment dispersion, a metal oxide, a polar solvent, and water. The pigment dispersion includes water, a polar solvent (which may be the same or different than the polar solvent in the inkjet ink composition), a cyan or magenta pigment, and a dye dispersion synergist having a structure of the corresponding pigment substituted with at least one solubilizing moiety selected from the group consisting of an ionic moiety, a non-ionic moiety, and a combination thereof. By “having a structure of the pigment”, it is meant that the dispersion synergist has the same unsubstituted backbone as the corresponding pigment. As an example, some of the quinacridone pigments disclosed herein have the quinacridone backbone and are substituted, for example, with an alkyl or a halogen. In these examples, the dispersion synergist has the quinacridone backbone, but not the alkyl or halogen substituent. The dispersion synergist may be water-soluble or at least water-miscible. Without being bound to any theory, it is believed that the water-soluble or water-miscible dispersion synergist interacts with the corresponding pigment to disperse the pigment in the aqueous medium of the pigment dispersion and of the inkjet ink composition. It has been found that the dispersability is also facilitated by the polar solvent. The dispersability of the pigment dispersion imparts stability to the ink, thus contributing to the jetting reliability and performance of the ink.

Moreover, the structural similarities between the pigment and the dispersion synergist disclosed herein render the two components chemically compatible, thus simplifying the chemistry involved in preparing the inks disclosed herein (e.g., when compared to making an ink with structurally different pigments and dispersants).

Additionally, and again without being bound to any theory, it is believed that within the inkjet ink, the metal oxide can interact with other metal oxide particles and/or with pigment particles to create a shear thinning network which maintains association with the pigments to improve color performance, especially on plain paper. The combination of these components, in their respective amounts as disclosed herein, have a synergistic effect which renders the ink performance independent of the components of the paper upon which it is printed.

The inks disclosed herein may also generate prints which are durable, e.g., in terms of water fastness, resistance to curling, etc. As illustrated in the examples set forth herein, the inkjet ink composition can be digitally jetted with a thermal inkjet printhead. It is to be understood, however, that the formulation may also be adjusted for a piezoelectric printhead.

Inkjet Ink Compositions

The inkjet ink composition comprises a pigment selected from the group consisting of a quinacridone and a phthalocyanine, a dispersion synergist having a structure of the pigment substituted with at least one solubilizing moiety selected from the group consisting of an ionic moiety, a non-ionic moiety, and a combination thereof, a metal oxide, a polar solvent, and water. In an example, the inkjet ink composition includes these components (e.g., pigment, dispersion synergist, metal oxide, polar solvent, etc.), as well as other additives suitable for inkjet inks, such as, sugar alcohol(s), anti-kogation agent(s), surfactant(s), humectant(s), biocide(s), materials for pH adjustment, sequestering agent(s), binder(s), and the like. In another example, the inkjet ink composition consists of a pigment, a dispersion synergist, a metal oxide, a polar solvent, and a balance of water. In these examples, the previously listed additives are not included in the ink.

In an example of the inkjet ink composition, the pigment and the dispersion synergist are present in a weight ratio of from about 8:1 to about 4:1. It has been found that these ratios of pigment to dispersion synergist, in the presence of the polar solvent, form a composition that is reliably jettable from a thermal inkjet printhead, water fast, and able to form prints with desirable attributes on plain and enhanced papers. It is believed that a similar pigment and the dispersion synergist weight ratio (i.e., from about 8:1 to about 4:1) may be incorporated into a composition that is reliably jettable from a piezoelectric inkjet printhead. This composition may have a higher total solids content (than the thermal inkjet composition) and may have more co-solvent than water. The higher solids and solvent-based formulation may be reliably jetted from a piezoelectric printhead without having a deleterious effect on print reliability or print performance on plain and enhanced papers.

In the examples disclosed herein, the pigment and dispersion synergist have a similar chemical structure, except the dispersion synergist is a dye derivative of the pigment. The dye derivative has the pigment chemical structure substituted with at least one solubilizing moiety selected from the group consisting of an ionic moiety, a non-ionic moiety, and a combination thereof.

In an example of the inkjet ink composition, the solubilizing moiety is the ionic moiety and the ionic moiety is selected from the group consisting of a sulfonate, a carboxylate, a phosphonate, and combinations thereof. Each of these moieties may be ionic or non-ionic, depending upon the pH of the solution containing the moiety. However, within the pH range of the inks disclosed herein (neutral or higher (i.e., more basic)), each of the sulfonate, carboxylate, and phosphonate moieties is in its ionic form, rather than its acid form. Some of the ionic moieties may be in salt form (e.g., SO₃⁻Na⁺, COO⁻Na⁺, K⁺H₂PO₃⁻) with any suitable cation, such as sodium or potassium.

In another example of the inkjet ink composition, the solubilizing moiety is the non-ionic moiety and the non-ionic moiety is selected from the group consisting of poly(ethylene glycol), a sulfonamide, a carboxamide, a urethane, and combinations thereof. The poly(ethylene glycol) may have a weight average molecular weight of 5,000 or less. In another example, the poly(ethylene glycol) may have a weight average molecular weight of 1,000 or less. The sulfonamide may be —SONH₂ and the carboxamide may be —CONH₂. The urethane may be −(CH₂)nOCONH₂ where n is 1 or 2.

In still another example of the inkjet ink composition, the solubilizing moiety includes the combination of the ionic moiety and the non-ionic moiety, wherein the ionic moiety is selected from the group consisting of a sulfonate, a carboxylate, and a phosphonate, and wherein the non-ionic moiety is selected from the group consisting of a sulfonamide and a carboxamide.

In an example, the inkjet ink composition is a cyan colored ink wherein the pigment is a copper phthalocyanine with a structure:

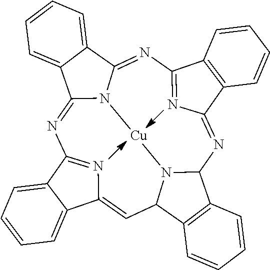

and the structure of the dispersion synergist one of:

i)

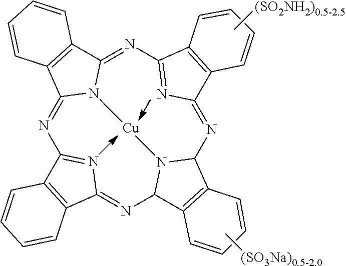

ii)

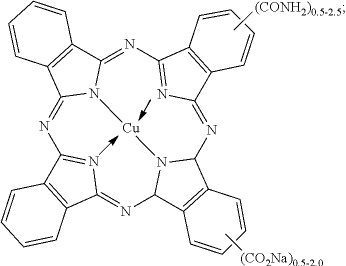

or

iii)

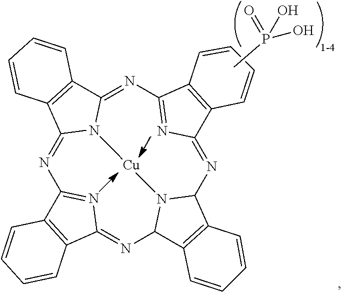

wherein at least one of the H protons is replaced by a Na⁺ or a K⁺ in the ink.

The copper phthalocyanine-based dispersion synergists with structures i or ii may include a cation other than sodium. For example, lithium, potassium or ammonium may replace the sodium (Na) cation.

Copper phthalocyanine, also known as Phthalocyanine blue or Pigment Blue 15, is the copper (II) complex of tetra aza tetra benzoporphine (CPC). Copper phthalocyanine is commercially available (for example, in powder or crystalline form, from Sigma-Aldrich). Copper phthalocyanine is insoluble in water, and thus is incapable of self-dispersion in water. As such, copper phthalocyanine may not be suitably incorporated into an aqueous-based inkjet ink without a suitable dispersant. Incorporation of copper phthalocyanine into an aqueous-based inkjet ink without a suitable dispersant will result in an unstable ink composition (i.e., an ink composition containing solid particulate matter that settles). Such an ink may be unsuitable for inkjet printing because the solids may block print head nozzles during use.

The various derivatives of copper phthalocyanine that are shown (i, ii, iii) and described are water-soluble, and can serve as a dispersant for the copper phthalocyanine pigment in the presence of the polar solvent disclosed herein. In an aqueous medium (including the polar solvent and water), copper phthalocyanine dye derivative may interact with the copper phthalocyanine pigment particles, resulting in the formation of a stable pigment dispersion which may be used to formulate examples of the aqueous-based inkjet inks disclosed herein.

The example copper phthalocyanine derivative (shown above as “i”) that is substituted with a sulfonate and a sulfonamide is known as Direct Blue 199 (or DB199), and may contain from 0.5 to 2 sulfonate moieties and from 0.5 to 2.5 sulfonamide moieties. This salt is also commercially available (for example, in powder or crystalline form, from Sigma-Aldrich).

While several examples of dye derivatives have been described for the dispersion synergist of copper phthalocyanine, it is to be understood that any other cyan dye based on the copper phthalocyanine structure may be used as the dispersion synergist.

In the examples disclosed herein, the copper phthalocyanine pigment may be present in the ink composition in an amount ranging from about 2 wt % to about 5 wt % based on the total weight of the inkjet ink composition. The amount of the dispersion synergist may depend upon the amount of pigment, and in an example, the weight ratio of pigment:dispersion synergist ranges from about 8:1 to about 4:1. As such, when the copper phthalocyanine pigment amount range from about 2 wt % to about 5 wt %, the copper phthalocyanine derivative dispersion synergist amount ranges from 0.25 wt % to about 1.25 wt % based on the total weight of the inkjet ink composition. In another example, the amount of copper phthalocyanine pigment in the cyan ink ranges from about 2 wt % to about 3 wt % based on the total weight of the inkjet ink composition. In still another example, the amount of copper phthalocyanine pigment in the cyan ink ranges from about 3.5 wt % to about 5 wt % based on the total weight of the inkjet ink composition. These percentages are percentages of the active pigment or dispersion synergist in the ink, and do not account for other components of a pigment dispersion (e.g., water, polar solvent) that may be added to the ink with the pigment and dispersion synergist.

In another example, the inkjet ink composition is a magenta colored ink, and the pigment is a quinacridone with a structure of:

i)

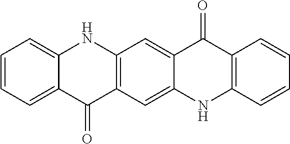 [SMILES: O=c1c2ccccc2[nH]c2cc3c(=O)c4ccccc4[nH]c3cc12]

ii)

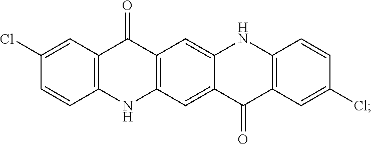 [SMILES: O=c1c2cc(Cl)ccc2[nH]c2cc3c(=O)c4cc(Cl)ccc4[nH]c3cc12]

or

iii)

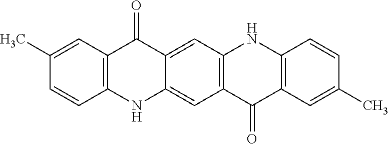

and the structure of the dispersion synergist is:

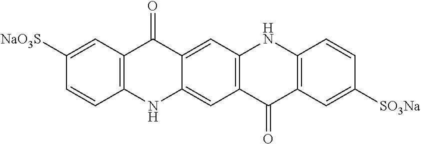

The quinacridone depicted herein at “i” is an unsubstituted quinacridone and is known as Pigment Violet 19.

The quinacridone depicted herein at “ii” is a halogenated quinacridone known as Pigment Red 202.

The quinacridone depicted herein at “iii” is 2,9-Dimethylquinacridone, also known as Pigment Red 122. 2,9-Dimethylquinacridone is commercially available (for example, in powder form as FAST PINK E from Hangzhou Aibai Chemical Co., Ltd.).

While several quinacridones have been shown and described, it is to be understood that any quinacridone magenta pigment may be used in the ink disclosed herein. Moreover, solid solutions of Pigment Red 122 and Pigment Violet 19 are available, and may be used in the inks disclosed herein.

Each of the quinacridone pigments is either insoluble in water or has a solubility no greater than 1.5% in water. As such, like copper phthalocyanine, the quinacridone pigments are or are essentially insoluble when incorporated into water, and may not be suitably incorporated into an aqueous-based medium without a suitable dispersant.

The sulfonated derivative of the unsubstituted quinacridone shown herein is water-soluble, and can serve as a dispersant for any of the quinacridone pigments disclosed herein in the presence of the polar solvent disclosed herein. The sulfonated quinacridone derivative shown herein may be prepared by any suitable method. In an example, the unsubstituted quinacridone may be heated in concentrated sulfuric acid, and then the quinacridone-sulfonic acid may be reacted with a suitable cation-containing aqueous solution. The cation may be sodium (as shown herein) or lithium, potassium or ammonium salts.

The sulfonated quinacridone derivative depicted herein has two ionic sulfonated moieties. In another example of the quinacridone dispersion synergist, one of ionic sulfonated moieties could be replaced with a non-ionic sulfonamide moiety. In still another example of the quinacridone dispersion synergist, both of the ionic sulfonated moieties could be replaced with non-ionic sulfonamide moieties.

In an example, the quinacridone pigment may be present in the inkjet ink composition in an amount ranging from about 2 wt % to about 5 wt % based on the total weight of the inkjet ink composition. The amount of the dispersion synergist may depend upon the amount of pigment, and in an example, the weight ratio of pigment:dispersion synergist ranges from about 8:1 to about 4:1. As such, when the quinacridone pigment amount range from about 2 wt % to about 5 wt %, the quinacridone derivative dispersion synergist amount ranges from 0.25 wt % to about 1.25 wt % based on the total weight of the inkjet ink composition. In another example, the amount of quinacridone pigment in a magenta ink ranges from about 2 wt % to about 3 wt % based on the total weight of the inkjet ink composition. In still another example, the amount of quinacridone pigment in the magenta ink ranges about 3.5 wt % to about 5 wt % based on the total weight of the inkjet ink composition. As noted herein, these percentages are percentages of the active pigment or dispersion synergist in the ink, and do not account for other components of a pigment dispersion (e.g., water, polar solvent) that may be added to the ink with the pigment and dispersion synergist.

Any example of the pigment and corresponding dispersion synergist may be incorporated into the inkjet ink composition in the form of a pigment dispersion, in which the pigment is dispersed with the dispersion synergist. The pigment dispersion will be discussed in further detail below in conjunction with the method.

The inkjet ink composition further includes a metal oxide. The metal oxide serves as a networking agent (or gelator), which may form an effective network that may contribute to more colorant remaining on the media surface after printing, even without the presence of calcium ions, thus resulting in an increase in color saturation on plain paper. The metal oxide particles (which desirably have some charge) interact with each other and/or with the pigment particles to form a three dimensional structure. As used herein, the term “metal oxide” refers to a molecule comprising at least one metal or semi-metal (e.g., Si) atom and at least one oxygen atom which in a particulate form is able to form the three dimensional structure (which is a structured network). As used herein, the term “semi-metal” includes boron, silicon, germanium, arsenic, antimony, and tellurium, for example. In an example, the inkjet ink composition includes a metal oxide, wherein the metal oxide is selected from the group consisting of silica, alumina, titania, and combinations thereof. As further examples, the metal oxide can include zinc oxide, iron oxide, indium oxide, zirconium oxide, or combinations thereof, including combinations with the previously listed examples.

The three dimensional structure may be enhanced in the presence of salt dissolved in the polar solvent and/or water. The salt can increase the interaction of the metal oxide particles, alone or in combination with the pigment particles. Salt that interacts with the metal oxide may be from the ionic moiety of the some examples of the dispersion synergist or from some another salt that may be added to the ink composition. The ionic moiety (salt) and/or another organic salt to the ink can act to shield the electrostatic repulsion between pigment particles and permit the Van der Waals interactions to increase, thereby forming a stronger attractive potential and resulting in a structured network by providing elastic content to a predominantly fluidic system. These structured systems show non-Newtonian flow behavior, thus providing useful characteristics for implementation in an inkjet ink because of their ability to shear or thermal thin for jetting. Once jetted, this feature allows the jetted drops to become more elastic-, mass-, or gel-like when they strike the media surface. These characteristics can also provide improved media attributes, such as colorant holdout on the surface of plain paper. The role of the ionic moiety (salt) and/or other salt can impact both the jettability and the response after jetting, as well as improving the dispersability of the pigment.

When silica is selected for the metal oxide, it is to be understood that different forms of silica may be used. Suitable forms of silica that may be used include anisotropic silica (e.g., elongated, covalently attached silica particles, such as PSM, which is commercially available from Nissan Chemical) or spherical silica dispersions (such as SNOWTEX® 30LH from Nissan Chemical). Other suitable commercially available silicas are sold under the tradename ORGANOSILICASOL™, which are organic solvent dispersed silica sols. In an example, the inkjet ink composition includes silica, wherein the silica is anisotropic silica, spherical silica or a combination of anisotropic silica and spherical silica. Anisotropic silica dispersions have a higher aspect ratio compared to spherical silica. One type of silica may be more suitable for use with a particular type of inkjet ink formulation relative to another type of inkjet ink formulation. For example, anisotropic silica dispersions may be more suited for cyan inks, whereas spherical silica dispersions may be more suitable for magenta inks.

As discussed herein, the metal oxide (again which is defined to include both metal and semi-metal oxides) can be present in the inkjet ink composition in an amount ranging from 0.5 wt % to 7 wt % based on the total weight of the inkjet ink composition. In one example, the metal oxide can be present in an amount ranging from about 1 wt % to about 5 wt %, based on the total weight of the inkjet ink composition. In another example, the metal oxide can be present in an amount ranging from about 0.5 wt % to about 2 wt %, based on the total weight of the inkjet ink composition.

Additionally, the geometry, including the size, shape and aspect ratio of the metal oxide can influence certain properties of the inkjet ink composition, such as viscosity. For example, at a given weight percent in an ink, metal oxide particles with a higher aspect ratio may yield a higher ink viscosity relative to metal oxide particles with a lower aspect ratio. Also, the viscosity of the ink may be reduced by incorporating a small amount of large sized particles, which act as spacers between pigment particles in the ink composition, and other smaller nanoparticle components that make up other solids in the ink. In this example, the large sized particles may mediate particle-particle interaction between the smaller nanoparticles to reduce viscosity. In one example, the particle size of the metal oxide may range from about 5 nm to about 50 nm. In another example, the particle size of the metal oxide may range from about 10 nm to about 25 nm. Suitable tools that may be used to measure the length and/or width of the metal oxide include SEM (Scanning Electron Microscopy), TEM (Transmission Electron Microscopy), AFM (Atomic Force Microscopy), and DLS (Dynamic Light Scattering).

The inkjet ink composition also includes a polar solvent and water. These components are part of an aqueous-based ink vehicle. As used herein, the term “aqueous-based ink vehicle” and “ink vehicle,” may refer to the liquid fluid in which the pigment, the corresponding synergist dispersant, and the metal oxide are placed to form the inkjet ink. When the pigment and synergist dispersant are part of a pigment dispersion prior to ink formation, the pigment dispersion and metal oxide may be added to the aqueous-based ink vehicle to form the inkjet ink composition. In these examples, it is to be understood that some of the water and polar solvent in the final ink composition is contributed by the liquids of the pigment dispersion. In an example, the aqueous-based ink vehicle includes water, the polar solvent, and other liquid additives. In another example, the aqueous-based ink vehicle includes the polar solvent and the water with no other liquid additives.

The polar solvent is a co-solvent in the inkjet ink. It is desirable for the co-solvent to be miscible with water, and thus the co-solvent has at least some degree of polarity. In an example, the co-solvent is selected from the group consisting of 2-pyrrolidone (2P), 1-(2-hydroxyethyl)-2-pyrrolidone (HE2P), 2-ethyl-2-hydroxymethyl-1,3-propanediol) (EHPD), tetraethylene glycol (TEG), sulfolane, and combinations thereof. The polar solvent (when used in thermal inkjet printing) may be present in an amount ranging from about 10 wt % to about 50 wt % based on the total weight of the inkjet ink composition. When the ink composition is to be used in piezoelectric inkjet printing, the polar solvent amount may be increased and the amount of water decreased. For example, when intended for piezoelectric printing, the amount of polar solvent may be greater than or equal to 50 wt %, based on the total weight of the inkjet ink composition. As mentioned herein, the polar solvent in the ink may be contributed by the pigment dispersion and by the aqueous-based ink vehicle. When the same polar solvent is used in the pigment dispersion and the ink vehicle, the final ink composition may include a single polar solvent. When different polar solvents are used in the pigment dispersion and the ink vehicle, the final ink composition may include different polar solvents. The polar solvent in the ink vehicle may contribute to enhancing the stability of the pigment dispersion.

The balance of the inkjet ink composition is water. As mentioned herein, the water in the ink may be contributed by the pigment dispersion and by the aqueous-based ink vehicle. As such, the amount of water included may vary, depending upon the amounts of the other inkjet ink components. In an example, the water is deionized water.

Examples of the inkjet ink composition may also include other components, such as a sugar alcohol, an organic salt, an anti-kogation agent, a surfactant, a humectant, a biocide, a material for pH adjustment, and the like, and combinations thereof.

As mentioned herein, the inkjet ink composition may further comprise a sugar alcohol. In an example, the sugar alcohol in the inkjet ink composition is present in an amount ranging from greater than 0 wt % up to about 15 wt % based on the total weight of the inkjet ink composition. The sugar alcohol can be any type of straight chain or cyclic sugar alcohol. In one example, the sugar alcohol can have the formula: H(HCHO)ₙ₊₁H, where n is at least 3. Such sugar alcohols can include erythritol (4-carbon), threitol (4-carbon), arabitol (5-carbon), xylitol (5-carbon), ribitol (5-carbon), mannitol (6-carbon), sorbitol (6-carbon), galactitol (6-carbon), fucitol (6-carbon), iditol (6-carbon), inositol (6-carbon; a cyclic sugar alcohol), volemitol (7-carbon), isomalt (12-carbon), maltitol (12-carbon), lactitol (12-carbon), and mixtures thereof. In one example, the sugar alcohol can be a 5 carbon sugar alcohol. In another example, the sugar alcohol can be a 6 carbon sugar alcohol. In still another example, the inkjet ink composition includes a sugar alcohol, wherein the sugar alcohol is selected from the group consisting of sorbitol, xylitol, mannitol, erythritol, and combinations thereof. The use of a sugar alcohol can improve the curl and rub/scratch resistance of prints formed with the ink.

Kogation refers to the deposit of dried ink on a heating element of a thermal inkjet printhead. Anti-kogation agent(s) is/are included to assist in preventing the buildup of kogation. Examples of suitable anti-kogation agents include oleth-3-phosphate (commercially available as CRODAFOS™ O3A or CRODAFOS™ N-3 acid) or dextran 500 k. Other suitable examples of the anti-kogation agents include CRODAFOS™ HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc. When included, the anti-kogation agent may be present in the inkjet ink composition in an amount ranging from about 0.05 wt % to about 1 wt % of the total weight of the inkjet ink composition. In the examples disclosed herein, the anti-kogation agent may improve the jettability of the inkjet ink composition.

The inkjet ink composition may also include an organic salt that is different from the ionic (salt) forms of the dispersion synergist. In an example, the inkjet ink composition further includes the organic salt present in an amount ranging from about 0.01 wt % to about 1 wt % based on the total weight of the inkjet ink composition. In another example, the organic salt may be present in an amount ranging from about 0.05 wt % to about 0.5 wt % based on the total weight of the inkjet ink composition.

Examples of the organic salt may include tetraethyl ammonium salts, tetramethyl ammonium salts, acetate salts, etc. In other examples, the organic salt can include salts of carboxylic acids (e.g., sodium or potassium 2-pyrrolidinone-5-carboxylic acid), sodium or potassium acetate, salts of citric acid or any organic acid including aromatic salts, and mixtures thereof. In one example, the organic salt is selected from the group consisting of sodium phthalate, tetraethyl ammonium, tetramethyl ammonium, monosodium glutamate, bis(trimethylsilyl) malonate, magnesium propionate, magnesium citrate, calcium acetate, magnesium acetate, sodium acetate, potassium acetate, barium acetate, and combinations thereof.

The presence of an organic salt, particularly a dissolved organic salt in the inkjet ink, can further contribute to the structured network described herein. The organic salt or the organic salt in combination with the salt form of the dispersion synergist can act to shield the electrostatic repulsion between pigment particles and permit the van der Waals interactions to increase, thereby forming a stronger attractive potential and resulting in a structured network (for the pigment) by providing elastic content to a predominantly fluidic system. As mentioned herein, these structured systems show non-Newtonian flow behavior, thus providing useful characteristics for implementation in an inkjet ink because of their ability to shear thin or thermal thin (in the case of thermal inkjet inks) for jetting. Once jetted, this feature allows the jetted drops to become more elastic-, mass-, or gel-like when they strike the media surface. These characteristics can also provide improved media attributes, such as colorant holdout on the surface of plain paper. Therefore, the role of the added organic salt can impact both the jettability of the inkjet ink as well as the response after jetting.

The inkjet ink composition may also include surfactant(s). Examples of suitable surfactants include sodium dodecyl sulfate (SDS), a linear, N-alkyl-2-pyrrolidone (e.g., SURFADONE™ LP-100 from Ashland Inc.), a self-emulsifiable, nonionic wetting agent based on acetylenic diol chemistry (e.g., SURFYNOL® SEF from Evonik Ind.), a nonionic fluorosurfactant (e.g., CAPSTONE® fluorosurfactants, such as CAPSTONE® FS-35, from Chemours), and combinations thereof. In other examples, the surfactant is an ethoxylated low-foam wetting agent (e.g., SURFYNOL® 440 or SURFYNOL® CT-111 from Evonik Ind.) or an ethoxylated wetting agent and molecular defoamer (e.g., SURFYNOL® 420 from Evonik Ind.). Still other suitable surfactants include non-ionic wetting agents and molecular defoamers (e.g., SURFYNOL® 104E from Evonik Ind.) or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TEGO® Wet 510 (polyether siloxane) available from Evonik Ind.). In some examples, it may be desirable to utilize a surfactant having a hydrophilic-lipophilic balance (HLB) less than 10. Whether a single surfactant is used or a combination of surfactants is used, the total amount of surfactant(s) in the inkjet ink composition may range from about 0.01 wt % to about 10 wt % based on the total weight of the inkjet ink composition. In an example, the total amount of surfactant(s) in the inkjet ink composition may be about 0.1 wt % based on the total weight of the inkjet ink composition.

The inkjet ink composition may also include humectant(s). In an example, the total amount of the humectant(s) present in the inkjet ink composition ranges from about 1 wt % to about 1.25 wt %, based on the total weight of the inkjet ink composition. An example of a suitable humectant is LIPONIC® EG-1 (i.e., LEG-1, glycereth-26, ethoxylated glycerol, available from Lipo Chemicals).

The inkjet ink composition may also include biocides (i.e., fungicides, anti-microbials, etc.). Example biocides may include the NUOSEPT™ (Troy Corp.), UCARCIDE™ (Dow Chemical Co.), ACTICIDE® B20 (Thor Chemicals), ACTICIDE® M20 (Thor Chemicals), ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof. Examples of suitable biocides include an aqueous solution of 1,2-benzisothiazolin-3-one (e.g., PROXEL® GXL from Arch Chemicals, Inc.), quaternary ammonium compounds (e.g., BARDAC® 2250 and 2280, BARQUAT® 50-65B, and CARBOQUAT® 250-T, all from Lonza Ltd. Corp.), and an aqueous solution of methylisothiazolone (e.g., KORDEK® MLX from Dow Chemical Co.). In an example, the inkjet ink composition may include a total amount of biocides that ranges from about 0.05 wt % to about 1 wt %, based on the total weight of the inkjet ink composition.

In an example, it may be desirable for the inkjet ink composition to have a pH ranging from about 7 to about 10, and pH adjuster(s) may be added to the inkjet ink composition to counteract any slight pH drop that may occur over time. The ionic moieties of some examples of the dispersion synergist will be in ionic form within this pH range. In an example, the total amount of pH adjuster(s) in the inkjet ink composition ranges from greater than 0 wt % to about 0.1 wt % (with respect to the total weight of the inkjet ink composition). Examples of suitable pH adjusters include metal hydroxide bases, such as sodium hydroxide (NaOH), potassium hydroxide (KOH), etc.

A total solids content of the inkjet ink composition (when used in thermal inkjet printing) ranges from about 2.5 wt % to about 12 wt % based on the total weight of the inkjet ink composition. When the ink composition is to be used in piezoelectric inkjet printing, the solids content may be increased. For example, when the inkjet ink composition is intended for use with piezoelectric inkjet printheads, a final ink solids content may range from about 10% to about 25% based on the total weight of the inkjet ink composition, without having a deleterious effect on print reliability or print performance.

Methods for Making the Inkjet Ink Composition

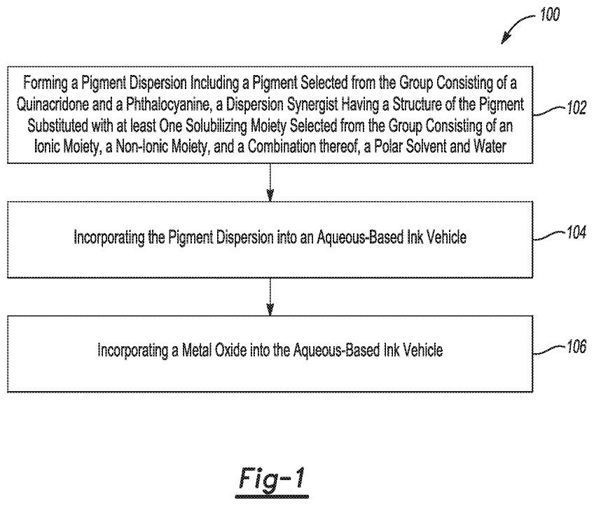

In addition to the inkjet ink composition described herein, a method 100 for making the inkjet ink composition is disclosed. Referring now to FIG. 1, the method 100 comprises forming a pigment dispersion including a pigment selected from the group consisting of a quinacridone and a phthalocyanine, a dispersion synergist having a structure of the pigment substituted with at least one solubilizing moiety selected from the group consisting of an ionic moiety, a non-ionic moiety, and a combination thereof, a polar solvent, and water (as shown at reference numeral 102); incorporating the pigment dispersion into an aqueous-based ink vehicle (as shown at reference numeral 104); and incorporating a metal oxide into the aqueous-based ink vehicle (as shown at reference numeral 106).

The preparation of the pigment dispersion involves a simple process, in part because the pigment and dispersion synergist are structurally similar and compatible. The respective pigment, i.e., the phthalocyanine or quinacridone pigment, and the corresponding sulfonated dispersion synergist are mixed together. The mixture may be added to a solution of the water and the polar solvent, or the solution of the water and the polar solvent may be added to the mixture. The components may be mixed with a suitable mixer until the dispersion is formed. In an example, mixing is accomplished with a mill and milling beads or another suitable high shear mixer. After mixing, the dispersion may be centrifuged to remove the milling beads.

In an example of the method 100, the pigment dispersion is a cyan or magenta colored dispersion. In an example where the pigment dispersion is a cyan colored dispersion, the pigment is a copper phthalocyanine with a structure:

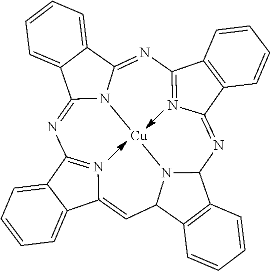

and the structure of the dispersion synergist one of:

i)

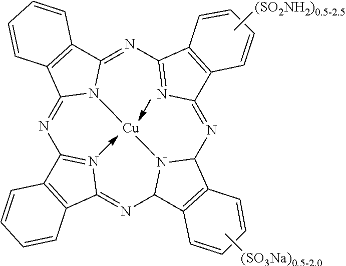

ii)

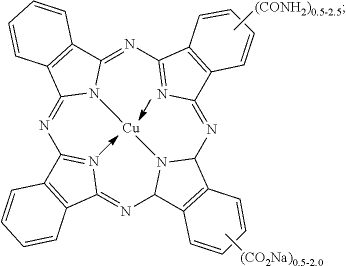

or

iii)

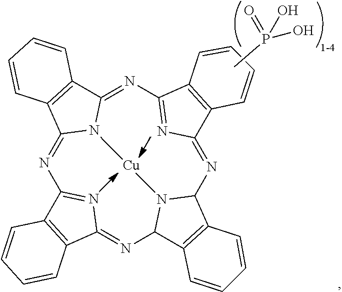

wherein at least one of the H protons is replaced by a Na⁺ or a K⁺.

In an example where the pigment dispersion is a magenta colored dispersion, the pigment is a quinacridone with a structure of:

i)

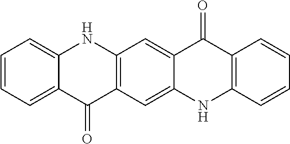 [SMILES: O=c1c2ccccc2[nH]c2cc3c(=O)c4ccccc4[nH]c3cc12]

ii)

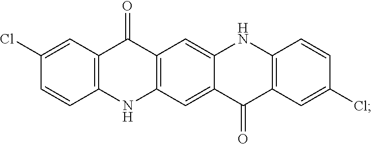 [SMILES: O=c1c2cc(Cl)ccc2[nH]c2cc3c(=O)c4cc(Cl)ccc4[nH]c3cc12]

or

iii)

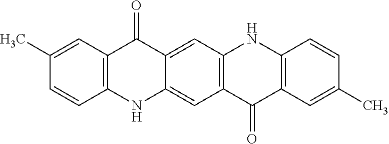

and the structure of the dispersion synergist is:

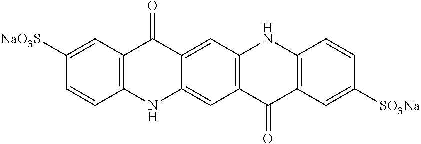

The pigment dispersion may include from about 10 wt % to about 20 wt % of the pigment (based on the total weight of the pigment dispersion), from about 1.25 wt % to about 5 wt % of the dispersion synergist (based on the total weight of the pigment dispersion), from about 15 wt % to about 25 wt % of the polar solvent (based on the total weight of the pigment dispersion), and a balance of water. In the pigment dispersion, the amount of the dispersion synergist may depend upon the amount of pigment and the desired weight ratio of pigment to dispersion synergist in the pigment dispersion and in the ink.

As shown at reference numeral 104, the pigment dispersion may then be incorporated into the aqueous-based ink vehicle. The amount of pigment dispersion added will depend upon the amount of pigment and dispersion synergist in the pigment dispersion and the desired weight of active pigment and active dispersion synergist that are to be present in the final ink. The amount of active pigment and active dispersion synergist are in accordance with the examples set forth herein for the ink composition. The aqueous-based ink vehicle may include a second polar solvent that is the same as or different than the polar solvent in the pigment dispersion and additional water (i.e., water that is not part of the pigment dispersion, and thus is in addition to the water of the pigment dispersion). In some examples, the aqueous-based vehicle may also include any of the liquid ink additives disclosed herein in any of the amounts disclosed herein. In other examples, water alone makes up the aqueous-based ink vehicle.

At reference numeral 106, the method 100 further includes incorporating a metal oxide into the aqueous-based ink vehicle. In an example, the metal oxide is added after the pigment dispersion is incorporated into the aqueous-based ink vehicle. In another example, the metal oxide is added into the aqueous-based ink vehicle before the pigment dispersion is incorporated into the aqueous-based ink vehicle. In still another example, the pigment dispersion and metal oxide are added into the aqueous-based ink vehicle simultaneously. Regardless of the order of adding the components, the final dispersion yields the inkjet ink composition. In an example of the method 100, the metal oxide is present in an amount ranging from 0.5 wt % up to 7 wt % based on the total weight of the inkjet ink composition.

In another example, the method 100 further comprises incorporating a sugar alcohol into the aqueous-based ink vehicle in an amount ranging from greater than 0 wt % up to about 15 wt % based on the total weight of the inkjet ink composition.

In the example method 100 shown in FIG. 1, the pigment and the dispersion synergist are added to the aqueous-based ink vehicle in the form of the pigment dispersion.

In an example of the method 100 that is suitable for making a thermal inkjet ink composition, the polar solvent may be present in an amount ranging from about 10 wt % to about 50 wt % based on the total weight of the inkjet ink composition, and a total solids content of the inkjet ink composition ranges from about 2.5 wt % to about 12 wt % based on the total weight of the thermal inkjet ink composition. To make an example of a piezoelectric inkjet formulation, the polar solvent amount and the solids content may be increased in accordance with the amounts set forth herein.

Printing Method

A printing method is also disclosed herein. The printing method comprises inkjet printing an inkjet ink composition onto a paper, the inkjet ink composition including a pigment selected from the group consisting of a quinacridone and a phthalocyanine, a dispersion synergist having a structure of the pigment substituted with one of: an ionic moiety selected from the group consisting of a sulfonate, a carboxylate, a phosphonate, and combinations thereof; or a non-ionic moiety selected from the group consisting of poly(ethylene glycol), a sulfonamide, a carboxamide, a urethane, and combinations thereof; or a combination of the ionic moiety and the non-ionic moiety, wherein the ionic moiety is selected from the group consisting of a sulfonate, a carboxylate, and a phosphonate, and the non-ionic moiety is selected from the group consisting of a sulfonamide and a carboxamide, a metal oxide, a polar solvent, and water.

The paper in the printing method may be either plain paper or enhanced paper. In some instances, the printing method including printing on plain paper and printing on enhanced paper in any order. In one example of the printing method, an image is formed by printing the ink composition disclosed herein on plain paper and another image is formed by printing the ink composition on enhanced paper (including an additive that produces a chemical interaction with the pigment in the ink composition). In this example, the average color saturation of the image on the plain paper is within 0.2 of the average color saturation of the other image on the enhanced paper at any given ink limit. Ink limit can be related to ink fill density or ink flux in terms of ink weight per pixel. For example, when the pixel is a 300^{th} of an inch by 300^{th} of an inch square, the ink limit may be defined as nanograms (ng) of ink per 300^{th} dots per inch (dpi) pixel, or, more simply, as nanograms (ng) per dots per inch (dpi) (such as ng/300 dpi).

In some examples of the printing method disclosed herein, the inkjet ink composition may be printed alone to generate cyan or magenta, or may be printed with another ink to form a secondary color (e.g., red, green, etc.). The other ink may be any suitable inkjet ink, and may or may not have similar components to the inks disclosed herein.

To further illustrate the present disclosure, examples are given herein. It is to be understood that these examples are provided for illustrative purposes and are not to be construed as limiting the scope of the present disclosure.

### EXAMPLES

### Example 1

Two example cyan pigment dispersions (Ex. PD1 and PD2) containing a cyan pigment and a corresponding dispersion synergist at different ratios were prepared in a water/polar solvent mixture. A comparative pigment dispersion (Comp. Ex. PD3) was also prepared with the cyan pigment and corresponding dispersion synergist, but water alone was used as the solvent (i.e., no polar solvent was used). The formulations of the example and comparative pigment dispersions are presented in Table 1 below. The percentages represent weight percentages of the individual components in the pigment dispersion.

TABLE 1

| | | Pigment dispersion | | |
|---|---|---|---|---|
| | Specific | Ex. PD1 | Ex. PD2 | Comp. Ex. PD3 |
| Ingredient | Component | (wt %) | (wt %) | (wt %) |
| Pigment | Pigment Blue 15 | 20 | 10 | 10 |
| Dispersion | Direct Blue 199 | 2.5 | 2.5 | 2.5 |
| Synergist | sodium salt | | | |
| Polar | 2-pyrrolidone | 20 | 20 | 0 |
| solvent | | | | |
| Water | Deionized Water | Balance | Balance | Balance |
| viscosity | | 3.5 | 2.2 | 1.3 |
| pH | | 7.78 | 7.76 | 7.99 |

The example and comparative example pigment dispersions were mixed and then filtered. Even with its low viscosity, Comp. Ex. PD3 had filterability issues, in part because the solids were not well dispersed. Thus, this comparative example was found to be unstable. These results indicate that the polar solvent impacts the stability of the pigment dispersion containing the cyan pigment and corresponding dye dispersion synergist. As such, it was found that the inclusion of the polar solvent (e.g., 2-pyrrolidone) in the preparation of the example pigment dispersions improved the stability of the example pigments dispersions Ex. PD1 and PD2.

To form two example cyan inkjet inks (Cyan Ink 1 and Cyan Ink 2), particular amounts of the respective pigment dispersions, Ex. PD1 and Ex. PD2, were then incorporated into an aqueous-based ink vehicle. Metal oxide was also added to the aqueous ink vehicle. The formulation of the example cyan inkjet inks is presented in Table 2 below. The percentages of the pigment and the dispersion synergist represent the amount of actives of each of these individual components in the inkjet ink composition. The 2-pyrrolidone was added as part of the pigment dispersions, and the water includes water from the pigment dispersions as well as additional water.

TABLE 2

| | | Cyan Ink 1 | Cyan Ink 2 |
|---|---|---|---|
| Ingredient | Specific Component | (wt %) | (wt %) |
| Network | Silica | 4 | 4 |
| Agent | Alumina | 1 | 1 |
| Polar | 1-(2-hydroxyethyl)-2- | 6 | 6 |
| Solvents | pyrrolidone | | |
| | 2-pyrrolidone from | 3 | 6 |
| | Ex. PD1 or PD2 | | |
| | Sulfolane | 6 | 6 |
| Sugar | Sorbitol | 10 | 10 |
| Alcohol | | | |
| Cyan | Pigment Blue 15 | 3 | 0 |
| pigment | from Ex. PD1 | | |
| | Pigment Blue 15 | 0 | 3 |
| | from Ex. PD2 | | |
| Dispersion | DB 199 Na salt | 0.375 | 0 |
| Synergist | from Ex. PD1 | | |
| | DB 199 Na salt | 0 | 0.75 |
| | from Ex. PD1 | | |
| Water | Deionized Water | Balance | Balance |
| pH 9.5-10 | | | |

The water, 1-(2-hydroxyethyl)-2-pyrrolidone, sulfolane, and sugar alcohol were mixed together to form the aqueous-based ink vehicle. The pH of the aqueous-based ink vehicle was adjusted to 10 using 1M NaOH. The alumina was added to the aqueous-based ink vehicle with vigorous mixing, followed by the addition of silica. This mixture was then added to the cyan pigment dispersion Ex. PD1 to form cyan ink 1, and to cyan pigment dispersion Ex. PD2 to form cyan ink 2. The pH of the inks was again adjusted to between 9.5 and 10, and was filtered using a 1.2 micron filter.

Comparative example cyan inkjet inks were also prepared or obtained to serve as positive and negative controls.

As a cyan positive control, the pigment dispersions of the examples cyan inks 1 and 2 were substituted with CAB-O-JET® 250C (commercially available from Cabot Corp.). CAB-O-JET® 250C includes a self-dispersed cyan pigment, produced by covalently attaching benzene sulfonic acid groups to the pigment surface by diazo coupling. The positive control ink including CAB-O-JET® 250C as the pigment dispersion is thus designated “cyan positive control”. The formulation of the positive control comparative inkjet ink is presented in Table 3 below. The percentage of the pigment dispersion represents the amount of active pigment in the positive control. As shown in Table 3, the formulation of the positive control comparative ink is identical to the formulations of the cyan example inks 1 and 2, except for the pigment dispersion (i.e., the pigment, the dispersant and any co-solvents of the pigment dispersion).

TABLE 3

| | | Cyan Positive |
|---|---|---|
| Ingredient | Specific Component | control (wt %) |
| Network Agent | Silica | 4 |
| | Alumina | 1 |
| Polar Solvent | 1-(2-hydroxyethyl)-2- | 6 |
| | pyrrolidone | |
| | Sulfolane | 6 |
| Sugar Alcohol | Sorbitol | 10 |
| Cyan Pigment | CAB-O-JET ® 250C | 3 |
| Dispersion | (Cabot Corp.) | |
| Water | Deionized Water | Balance |
| pH 10 | | |

As a negative control, the cyan ink in HP 971 cartridges was used. This ink is designated “cyan negative control”. The cyan negative control comparative ink did not include metal oxides or a dispersion synergist. The cyan negative control did include a cyan pigment and a dispersant, but the dispersant was not a corresponding dispersion synergist as disclosed herein.

The example cyan inks 1 and 2 were part of ink set 1 (“Set1”) and ink set 2 (“Set2”), respectively. The cyan negative control was part of comparative ink set 3 (CompSet3) and the positive control was part of comparative ink set 4 (CompSet4). Each of these example ink sets and comparative example ink sets also included a respective yellow ink. The yellow ink of Set1 and Set2 had the formulation set forth in Table 3, except that the CAB-O-JET® 250C (Cabot Corp.) cyan pigment dispersion was replaced with CAB-O-JET® 740Y (Cabot Corp.) yellow pigment dispersion at 3.5 wt % active yellow pigment. The yellow ink of CompSet3 was the yellow ink in HP 971 cartridges (i.e., negative control and thus did not include metal oxide or the dispersion synergist), which includes about 3.5 wt % active yellow pigment. The yellow ink of CompSet4 had the formulation set forth in Table 3 (i.e., positive control), except that the CAB-O-JET® 250C (Cabot Corp.) cyan pigment dispersion was replaced with CAB-O-JET® 270Y (Cabot Corp.) yellow pigment dispersion at 3.5 wt % active yellow pigment.

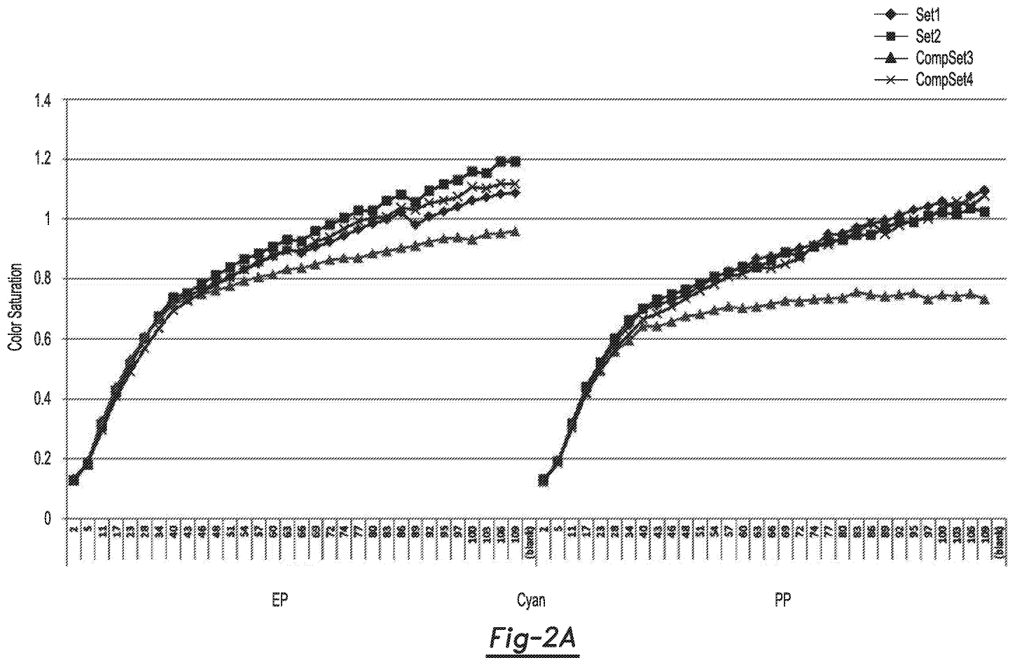

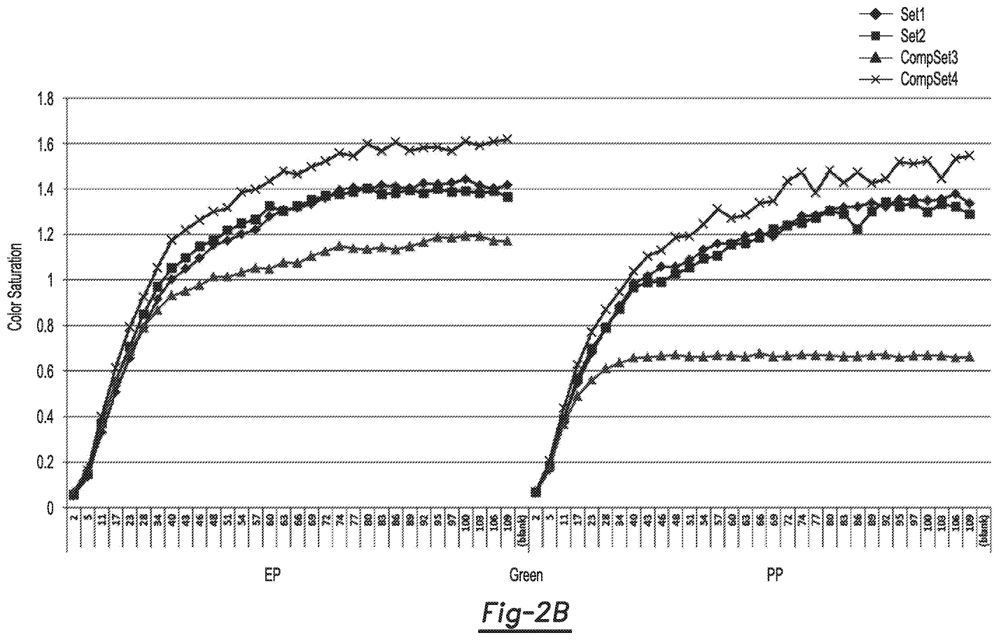

The various ink sets were used to print cyan images. More specifically, the example cyan inks 1 and 2 of Set1 and Set2, the cyan negative control of CompSet3, and the cyan positive control of CompSet4 were printed with a thermal inkjet printer, HP® OFFICEJET® Pro 8000, on a plain paper (Staples copy paper, referred to herein as PP), and on an enhanced paper (HP® Multipurpose paper media with COLORLOK® technology, referred to herein as EP). The various cyan inks were printed at different ink levels (ranging from 2 to 109 on the plain paper and from 2 to 106 on the enhanced paper). The color saturation of each cyan printed image was measured using an EXACT™ spectrophotometer, from X-Rite Pantone. The color saturation results for the cyan images are shown in FIG. 2A, with the results on enhanced paper (EP) at the left and the results on plain paper (PP) at the right.

The various ink sets were also used to print green images. Green is a secondary color that can be formed by printing the cyan and yellow of the respective ink sets together. More specifically, the thermal inkjet printer was used to print i) the example cyan ink 1 and the yellow ink of Set1 together to form green images on the plain and enhanced papers; ii) the example cyan ink 2 and the yellow ink of Set2 together to form green images on the plain and enhanced papers; iii) the cyan negative control and the yellow of CompSet3 together to form green images on the plain and enhanced papers; and iv) the cyan positive control and the yellow of CompSet4 together to form green images on the plain and enhanced papers. The respective cyan and yellow inks were printed at a ratio of C:Y ratio of 0.56:1. The color saturation of each green printed image was measured using the EXACT™ spectrophotometer, from X-Rite Pantone. The color saturation results for the green images are shown in FIG. 2B, with the results on enhanced paper (EP) at the left and the results on plain paper (PP) at the right.

As shown in FIGS. 2A and 2B, the cyan images and the green images formed with the cyan negative control ink (CompSet3, printed alone for the cyan images or with yellow for the green images) exhibited a better average color saturation on the enhanced paper than on the plain paper. The better performance exhibited by the comparative negative control ink on the enhanced paper compared to the plain paper is likely due to the COLORLOK® technology in the enhanced paper.

Furthermore, on both paper types, the cyan and green images formed with the cyan negative control ink performed worse, in terms of color saturation, than the cyan and green images formed, respectively, with the example cyan inks 1 and 2 (Set1 and Set2) and the cyan positive control (CompSet4). Initially, all the ink sets exhibited a similar upward trend in color saturation as the ink limit increased on each of the enhanced and plain papers. For all of the inks, this upward trend was not as aggressive at ink levels at and above about 40. However, for the cyan images printed with the cyan negative control ink at ink levels at and above about 40, the color saturation was much lower than the other cyan images. Similar results were observed for the green images, except that the green image on plain paper formed with the cyan negative control ink did not have any increase in color saturation at ink levels past about 40. These results indicate that the metal oxides contribute to the improved color saturation, because the cyan negative control did not include any metal oxides.

Contrary to the performance of the cyan negative control, the cyan and green images formed with the example cyan inks 1 and 2 (Set1 and Set2) respectively exhibited comparable color saturation to that of the cyan and green images formed with the cyan positive control (CompSet4). The cyan image results (FIG. 2A) indicate that the pigment dispersions (PD1, PD2) disclosed herein (including the dispersion synergist) performs as well or better than a commercially available pigment dispersion including metal or semi-metal oxide (in the positive control cyan ink of CompSet4) when the corresponding ink (1, 2) is printed alone to form cyan prints. The green image results (FIG. 2B) also indicate that the pigment dispersions (PD1, PD2) disclosed herein (including the dispersion synergist) performs almost as good as a commercially available pigment dispersion including metal or semi-metal oxide (in the positive control cyan ink of CompSet4) when the corresponding ink (1, 2) is printed together with yellow ink to form green prints.

Moreover, the cyan and green images formed with the example cyan inks 1 and 2 (Set1 and Set2) each exhibited relatively consistent color saturation performance across the plain and enhanced papers. These results illustrate that both the examples cyan inks 1 and 2 are media independent in terms of color performance.

### Example 2

An example magenta pigment dispersion (Ex. PD4) containing a magenta pigment and a corresponding dispersion synergist was prepared in a water/polar solvent mixture. The formulation of the example pigment dispersion is presented in Table 4 below. The percentages represent weight percentages of the individual components in the pigment dispersion.

TABLE 4

| | Specific | Ex. PD4 |
|---|---|---|
| Ingredient | Component | (wt %) |
| Pigment | Pigment Red 122 | 10 |
| Dispersion | Disulfonate of | 1.7 |
| Synergist | Pigment Violet 19 | |
| Water | Deionized Water | Balance |

The example was mixed and then filtered. The filterability indicated that the example magenta pigment dispersion was stable.

To form an example magenta inkjet ink (Magenta Ink 5), an amount of the pigment dispersion PD4 was incorporated into an aqueous-based ink vehicle. Metal oxide was also added to the aqueous ink vehicle. The formulation of the example magenta inkjet ink is presented in Table 5 below. The percentage of the pigment and the dispersion synergist represent the amount of actives of each of these individual components in the inkjet ink composition. The water includes water from the pigment dispersion as well as additional water.

TABLE 5

| | | Magenta Ink 5 |
|---|---|---|
| Ingredient | Specific Component | (wt %) |
| Network | Silica | 4 |
| Agent | Alumina | 1 |
| Polar | 1-(2-hydroxyethyl)-2- | 6 |
| Solvents | pyrrolidone | |
| | Sulfolane | 6 |
| Sugar | Sorbitol | 10 |
| Alcohol | | |
| Magenta | PR 122 | 3.5 |
| pigment | from Ex. PD4 | |
| Dispersion | Disulfonate of PR 122 | 0.595 |
| Synergist | from Ex. PD4 | |
| Water | Deionized Water | Balance |
| pH 9.5-10 | | |

The water, 1-(2-hydroxyethyl)-2-pyrrolidone sulfolane, and sugar alcohol were mixed together to form the aqueous-based ink vehicle. The pH of the aqueous-based ink vehicle was adjusted to 10 using 1M NaOH. The alumina was added to the aqueous-based ink vehicle with vigorous mixing, followed by the addition of silica. This mixture was then added to the magenta pigment dispersion Ex. PD4 to form magenta ink 5. The pH of the ink was again adjusted to between 9.5 and 10, and was filtered using a 1.2 micron filter.

Comparative example magenta inkjet inks were also prepared or obtained to serve as positive and negative controls.

As a magenta positive control, the pigment dispersion of the example magenta ink 5 was substituted with CAB-O-JET® 260M (commercially available from Cabot Corp.). CAB-O-JET® 260M includes a self-dispersed magenta pigment, produced by covalently attaching benzene sulfonic acid groups to the pigment surface by diazo coupling. The positive control ink including CAB-O-JET® 260M as the pigment dispersion is thus designated “magenta positive control”. The formulation of the magenta positive control comparative inkjet ink is presented in Table 6 below. The percentage of the pigment dispersion represents the amount of active pigment in the positive control. As shown in Table 6, the formulation of the magenta positive control comparative ink is identical to the formulation of magenta example ink 5, except for the pigment dispersion.

TABLE 6

| | | Magenta Positive |
|---|---|---|
| Ingredient | Specific Component | control (wt %) |
| Network Agent | Silica | 4 |
| | Alumina | 1 |
| Polar Solvent | 1-(2-hydroxyethyl)-2- | 6 |
| | pyrrolidone | |
| | Sulfolane | 6 |
| Sugar Alcohol | Sorbitol | 10 |
| Cyan Pigment | CAB-O-JET ® 260M | 3.5 |
| Dispersion | (Cabot Corp.) | |
| Water | Deionized Water | Balance |
| pH 10 | | |

As a negative control, the magenta ink in HP 971 cartridges was used. This ink is designated “magenta negative control”. The magenta negative control comparative ink did not include metal oxides or a dispersion synergist. The magenta negative control did include a magenta pigment and a dispersant, but the dispersant was not a corresponding dispersion synergist as disclosed herein. The example magenta ink 5 was part of ink set 5 (“Set5”). The magenta negative control was part of comparative ink set 6 (CompSet6) and the magenta positive control was part of comparative ink set 7 (CompSet7). Each of these example ink sets and comparative example ink sets also included a respective yellow ink. The yellow ink of Set5 had the formulation set forth in Table 7, except that the CAB-O-JET® 260M (Cabot Corp.) magenta pigment dispersion was replaced with CAB-O-JET® 740Y (Cabot Corp.) yellow pigment dispersion at 3.5 wt % active yellow pigment. The yellow ink of CompSet6 was the yellow ink in HP 971 cartridges (i.e., negative control and thus did not include metal oxide or the dispersion synergist), which includes about 3.5 wt % active yellow pigment. The yellow ink of CompSet7 had the formulation set forth in Table 6 (i.e., positive control), except that the CAB-O-JET® 260M (Cabot Corp.) cyan pigment dispersion was replaced with CAB-O-JET® 270Y (Cabot Corp.) yellow pigment dispersion at 3.5 wt % active yellow pigment.

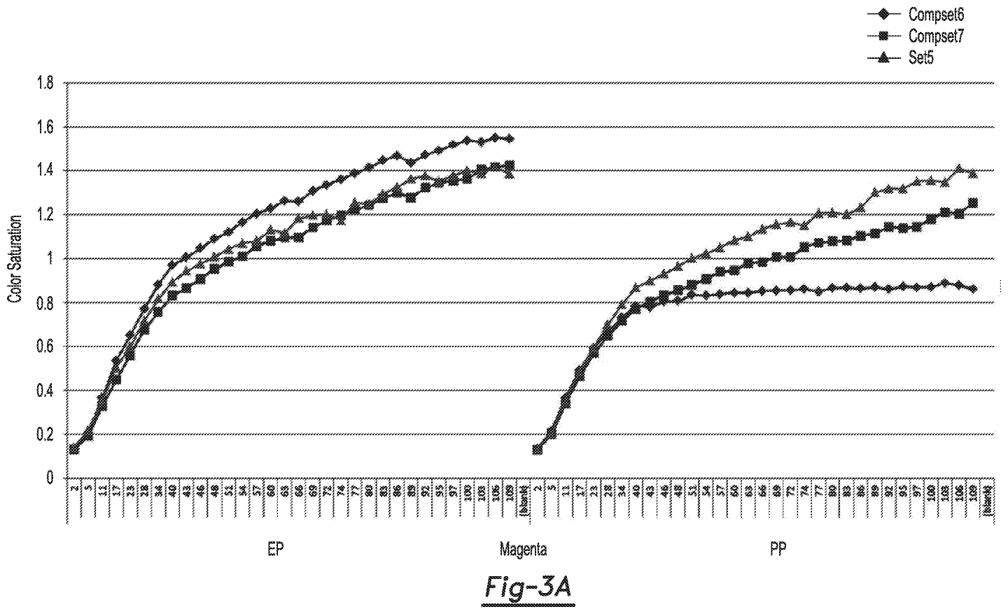

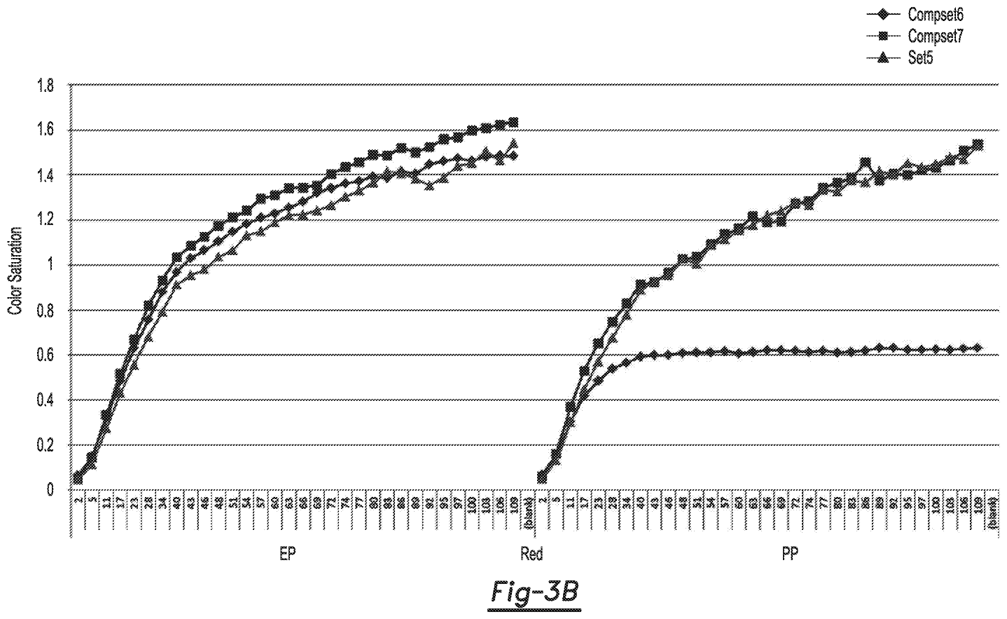

The various ink sets were used to print magenta images. More specifically, the example magenta ink 5 of Set5, the magenta negative control of CompSet6, and the magenta positive control of CompSet7 were printed with a thermal inkjet printer, HP® OFFICEJET® Pro 8000, on a plain paper (Staples copy paper, referred to herein as PP), and on an enhanced paper (HP® Multipurpose paper media with COLORLOK® technology, referred to herein as EP). The various magenta inks were printed at different ink levels (ranging from 2 to 109 on the plain paper and from 2 to 106 on the enhanced paper). The color saturation of each magenta printed image was measured using an EXACT™ spectrophotometer, from X-Rite Pantone. The color saturation results for the magenta images are shown in FIG. 3A, with the results on enhanced paper (EP) at the left and the results on plain paper (PP) at the right.

The various ink sets were also used to print red images. Red is a secondary color that can be formed by printing the magenta and yellow of the respective ink sets together. More specifically, the thermal inkjet printer was used to print i) the example magenta ink 5 and the yellow ink of Set5 together to form red images on the plain and enhanced papers; ii) the magenta negative control and the yellow of CompSet6 together to form red images on the plain and enhanced papers; and iii) the magenta positive control and the yellow of CompSet7 together to form red images on the plain and enhanced papers. The respective magenta and yellow inks were printed at a ratio of M:Y ratio of 1.27:1. The color saturation of each red printed image was measured using the EXACT™ spectrophotometer, from X-Rite Pantone. The color saturation results for the red images are shown in FIG. 3B, with the results on enhanced paper (EP) at the left and the results on plain paper (PP) at the right.

As shown in FIGS. 3A and 3B, the magenta images and the red images formed with the magenta negative control ink (CompSet6, printed alone for the magenta images or with yellow for the red images) exhibited a better average color saturation on the enhanced paper than on the plain paper. The better performance exhibited by the comparative magenta negative control ink on the enhanced paper compared to the plain paper is likely due to the COLORLOK® technology in the enhanced paper. These results indicate that the metal oxides contribute to the improved color saturation on plain paper, because the magenta negative control did not include any metal oxides.

Contrary to the performance of the magenta negative control, the magenta and red images formed with the example magenta ink 5 (Set5) respectively exhibited comparable color saturation to that of the magenta and red images formed with the magenta positive control (CompSet7). The magenta image results (FIG. 3A) indicate that the pigment dispersion PD4 disclosed herein (including the dispersion synergist) performs as well or better than a commercially available pigment dispersion (in the magenta ink of CompSet7) when the corresponding ink (5) is printed alone to form magenta prints. The red image results (FIG. 3B) also indicate that the pigment dispersion PD4 disclosed herein (including the dispersion synergist) performs almost as good as a commercially available pigment dispersion (in the magenta ink of CompSet7) when the corresponding ink (5) is printed together with yellow ink to form red prints.

Moreover, the magenta and red images formed with the example magenta ink 5 (Set5) exhibited relatively consistent color saturation performance across the plain and enhanced papers. These results illustrate that the example magenta ink 5 is media independent in terms of color performance.

It is to be understood that the ranges provided herein include the stated range and any value or sub-range within the stated range, as if the value(s) or sub-range(s) within the stated range were explicitly recited. For example, a range from 0.5 wt % up to 7 wt % should be interpreted to include not only the explicitly recited limits of 0.5 wt % up to 7 wt %, but also to include individual values, such as 0.75 wt %, 1.25 wt %, 4 wt %, 6.55 wt %, etc., and sub-ranges, such as from about 0.55 wt % to about 3 wt %, from about 1.5 wt % to about 5.7 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. An inkjet ink composition, comprising:
a pigment selected from the group consisting of a quinacridone and a phthalocyanine;
a dispersion synergist having a structure of the pigment substituted with at least one solubilizing moiety selected from the group consisting of an ionic moiety, a non-ionic moiety and a combination thereof;
a metal oxide;
a polar solvent; and
water.

2. The inkjet ink composition as defined in claim 1 wherein the solubilizing moiety is the ionic moiety and the ionic moiety is selected from the group consisting of a sulfonate, a carboxylate, a phosphonate, and combinations thereof.

3. The inkjet ink composition as defined in claim 1 wherein the solubilizing moiety is the non-ionic moiety and the non-ionic moiety is selected from the group consisting of poly(ethylene glycol), a sulfonamide, a carboxamide, a urethane, and combinations thereof.

4. The inkjet ink composition as defined in claim 1 wherein the solubilizing moiety includes the combination of the ionic moiety and the non-ionic moiety, wherein the ionic moiety is selected from the group consisting of a sulfonate, a carboxylate, and a phosphonate, and wherein the non-ionic moiety is selected from the group consisting of a sulfonamide and a carboxamide.

5. The inkjet ink composition as defined in claim 1 wherein:
the inkjet ink composition is a cyan colored ink;
the pigment is a copper phthalocyanine with a structure: 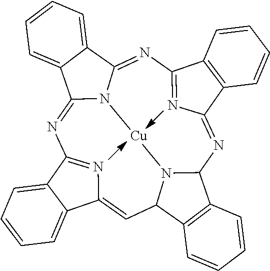
and the structure of the dispersion synergist is one of:
i) 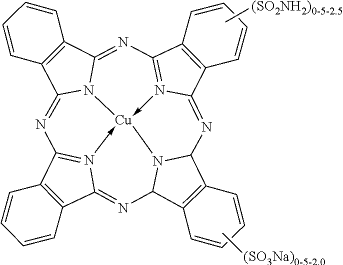
ii) 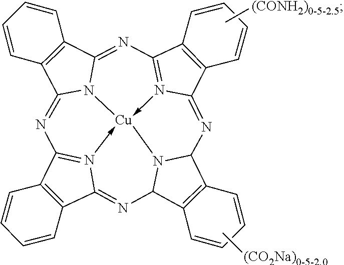
or
iii) 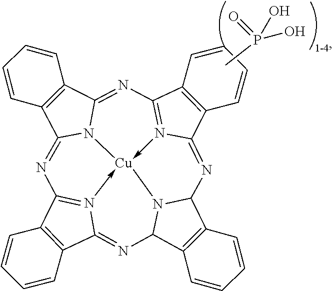
wherein at least one of the H protons is replaced by a Na⁺ or a K⁺.

6. The inkjet ink composition as defined in claim 1 wherein:
the inkjet ink composition is a magenta colored ink;
the pigment is a quinacridone with a structure of:
i) 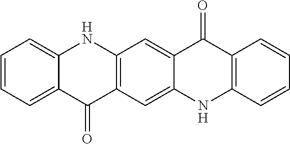 [SMILES: O=c1c2ccccc2[nH]c2cc3c(=O)c4ccccc4[nH]c3cc12]
ii) 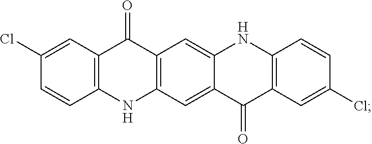 [SMILES: O=c1c2cc(Cl)ccc2[nH]c2cc3c(=O)c4cc(Cl)ccc4[nH]c3cc12]
or
iii) 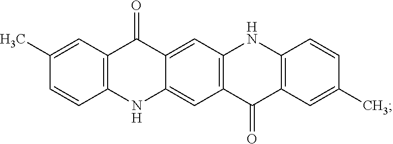 [SMILES: Cc1ccc2[nH]c3cc4c(=O)c5cc(C)ccc5[nH]c4cc3c(=O)c2c1]
and the structure of the dispersion synergist is:

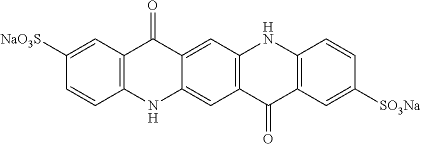

7. The inkjet ink composition as defined in claim 1 wherein the pigment and the dispersion synergist are present in a weight ratio of from about 8:1 to about 4:1.

8. The inkjet ink composition as defined in claim 1, further comprising a sugar alcohol present in an amount ranging from greater than 0 wt % up to about 15 wt % based on the total weight of the inkjet ink composition.

9. The inkjet ink composition as defined in claim 1 wherein the metal oxide is selected from the group consisting of silica, alumina, titania, and combinations thereof.

10. The inkjet ink composition as defined in claim 1 wherein the metal oxide is present in an amount ranging from 0.5 wt % up to 7 wt % based on the total weight of the inkjet ink composition.

11. A method for making an inkjet ink composition, comprising:
forming a pigment dispersion including:
a pigment selected from the group consisting of a quinacridone and a phthalocyanine;
a dispersion synergist having a structure of the pigment substituted with at least one solubilizing moiety selected from the group consisting of an ionic moiety, a non-ionic moiety, and a combination thereof;
a polar solvent; and
water;
incorporating the pigment dispersion into an aqueous-based ink vehicle; and
incorporating a metal oxide into the aqueous-based ink vehicle.

12. The method as defined in claim 11 wherein one of:
the solubilizing moiety is the ionic moiety and the ionic moiety is selected from the group consisting of a sulfonate, a carboxylate, a phosphonate, and combinations thereof; or
the solubilizing moiety is the non-ionic moiety and the non-ionic moiety is selected from the group consisting of poly(ethylene glycol), a sulfonamide, a carboxamide, a urethane, and combinations thereof;
the solubilizing moiety includes the combination of the ionic moiety and the non-ionic moiety, and wherein the ionic moiety is selected from the group consisting of a sulfonate, a carboxylate, and a phosphonate, and the non-ionic moiety is selected from the group consisting of a sulfonamide and a carboxamide.

13. The method as defined in claim 11 wherein:
the pigment dispersion is a cyan colored dispersion;
the pigment is a copper phthalocyanine with a structure: 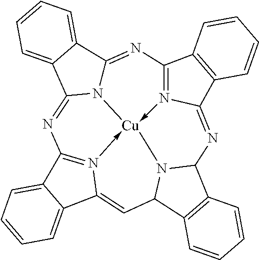
and the structure of the dispersion synergist is one of:
i) 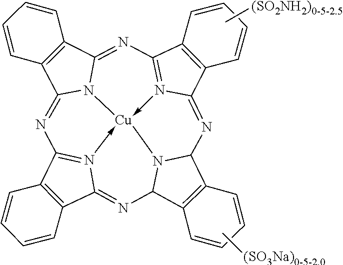
ii) 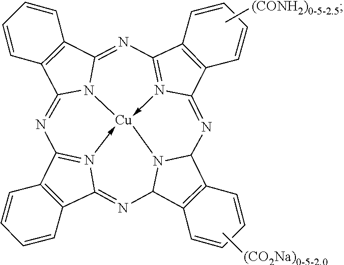
or
iii) 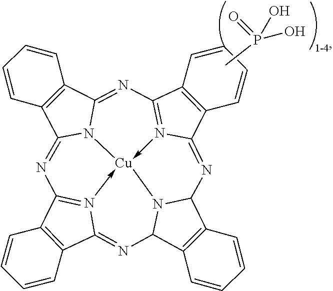
wherein at least one of the H protons is replaced by a Na⁺ or a K⁺.

14. The method as defined in claim 11 wherein:
the pigment dispersion is a magenta colored dispersion;
the pigment is a quinacridone with a structure of:
i) 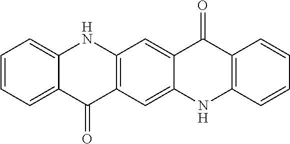 [SMILES: O=c1c2ccccc2[nH]c2cc3c(=O)c4ccccc4[nH]c3cc12]
ii) 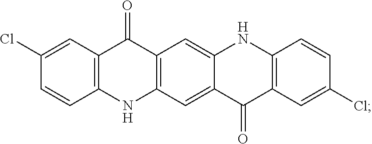 [SMILES: O=c1c2cc(Cl)ccc2[nH]c2cc3c(=O)c4cc(Cl)ccc4[nH]c3cc12]
or
iii) 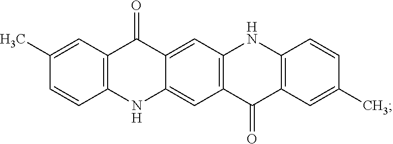 [SMILES: Cc1ccc2[nH]c3cc4c(=O)c5cc(C)ccc5[nH]c4cc3c(=O)c2c1]
and the structure of the dispersion synergist is:

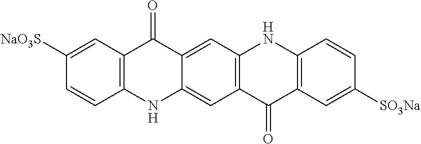

15. A printing method, comprising:
inkjet printing an inkjet ink composition onto a paper, the inkjet ink composition including:
a pigment selected from the group consisting of a quinacridone and a phthalocyanine;
a dispersion synergist having a structure of the pigment substituted with one of:
an ionic moiety selected from the group consisting of a sulfonate, a carboxylate, a phosphonate, and combinations thereof; or
a non-ionic moiety selected from the group consisting of poly(ethylene glycol), a sulfonamide, a carboxamide, a urethane, and combinations thereof; or
a combination of the ionic moiety and the non-ionic moiety, wherein the ionic moiety is selected from the group consisting of a sulfonate, a carboxylate, and a phosphonate, and the non-ionic moiety is selected from the group consisting of a sulfonamide and a carboxamide;
a metal oxide;
a polar solvent; and
water.
